(19) United States
(12) Patent Application Publication
(10) Pub. No.: US 2026/0024763 A1
(43) Pub. Date: Jan. 22, 2026

(54) Secondary Battery

(71) Applicant: Nippon Telegraph and Telephone Corporation, Tokyo (JP)

(72) Inventors: Shuhei Sakamoto, Musashino-shi, Tokyo (JP); Masaya Nohara, Musashino-shi, Tokyo (JP); Sho Okubo, Musashino-shi, Tokyo (JP); Hiroaki Taguchi, Musashino-shi, Tokyo (JP); Takeshi Komatsu, Musashino-shi, Tokyo (JP)

(21) Appl. No.: 18/868,483

(22) PCT Filed: May 24, 2022
(86) PCT No.: PCT/JP2022/021243

§ 371 Date: Nov. 22, 2024

(51) Int. Cl. H01M 4/60; H01M 4/38; H01M 4/66; H01M 10/054; H01M 50/109

(52) U.S. Cl. CPC H01M 4/60; H01M 4/38; H01M 4/661; H01M 10/054; H01M 50/109

(57) ABSTRACT

The secondary battery includes a positive electrode containing indigo, a negative electrode containing magnesium, sodium, or calcium, and an electrolyte disposed between the positive electrode and the negative electrode.

### TECHNICAL FIELD

The present invention relates to a secondary battery.

### BACKGROUND ART

In the related art, for small devices, sensors, mobile apparatuses, and the like, alkaline batteries, manganese batteries, high-performance coin-type lithium secondary batteries, nickel-cadmium batteries, nickel-hydride batteries, lithium-ion batteries, and the like are widely used as disposable primary batteries and rechargeable secondary batteries.

With the recent development of the Internet of Things (IoT), the development of distributed sensors which can be installed throughout the natural world such as in soil and forests is also progressing. Furthermore, air batteries with low environmental impact are being studied (PTL 1).

### CITATION LIST

### Patent Literature

[PTL 1] Japanese Patent No. 6711915

### SUMMARY OF INVENTION

### Technical Problem

Batteries in the related art use materials which have a high environmental impact such as lead compounds, cadmium compounds, manganese compounds, nickel compounds, and fluorine compounds and require special treatment when discarded. For this reason, such batteries in the related art are not suitable for disposal as general garbage or for installing in distributed sensors. Therefore, there is a need for a battery constructed only from materials with low environmental impact.

The battery principle of PTL 1 is an air battery. Since air batteries use oxygen in the air as a positive electrode active material, an air intake port is essential for the battery. For this reason, air batteries have the disadvantage that the electrolyte evaporates from the air intake port, making them unsuitable for long-term storage. Therefore, there is a need for a new secondary battery which does not require oxygen in the positive electrode active material and has a low environmental impact.

Secondary batteries can be charged and discharged and used repeatedly. For this reason, the amount of waste can be reduced and the environmental impact is low compared to primary batteries of the same capacity and voltage.

The present invention was made in view of the above circumstances, and an object of the present invention is to provide a secondary battery which has a low environmental impact and can be stored for a long period of time.

### Solution to Problem

A secondary battery according to an aspect of the present invention includes a positive electrode containing indigo dye; a negative electrode containing magnesium, sodium or calcium; and an electrolyte disposed between the positive electrode and the negative electrode.

### Advantageous Effects of Invention

According to the present invention, it is possible to provide a secondary battery which has a low environmental impact and can be stored for a long period of time.

### BRIEF DESCRIPTION OF DRAWINGS

FIG. 1 is a basic schematic diagram of a secondary battery of an embodiment.

FIG. 2 is a schematic cross-sectional view showing a structure of a coin-type secondary battery.

### DESCRIPTION OF EMBODIMENTS

Embodiments of the present invention will be described below with reference to the drawings.

### [Configuration of Secondary Battery]

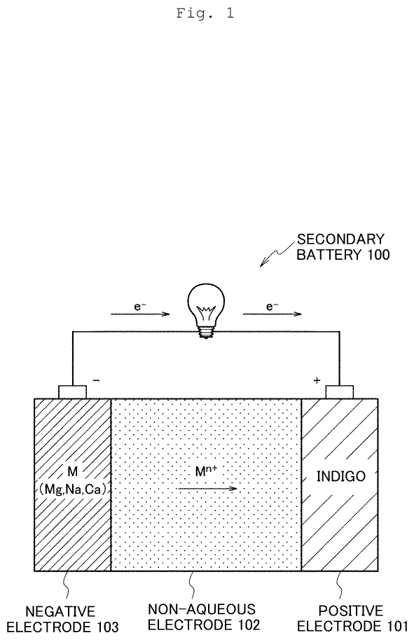

FIG. 1 is a configuration diagram showing a configuration of a secondary battery in an embodiment of the present invention. The secondary battery includes a positive electrode 101 containing indigo, a negative electrode 103 containing magnesium, sodium, or calcium, and an electrolyte 102 disposed between the positive electrode 101 and the negative electrode 103. As the electrolyte 102, it is preferable to use a non-aqueous electrolyte 102. Although a case in which the aqueous electrolyte 102 is used as the electrolyte 102 will be described as an example in the embodiment, the present invention is not limited thereto.

Although the embodiment will be described below, the present invention is not limited thereto as long as the gist thereof is not changed.

The charge/discharge reaction at the negative electrode 103 is shown in equation (1) and the charge/discharge reaction at the positive electrode 101 is shown in Expression (2).

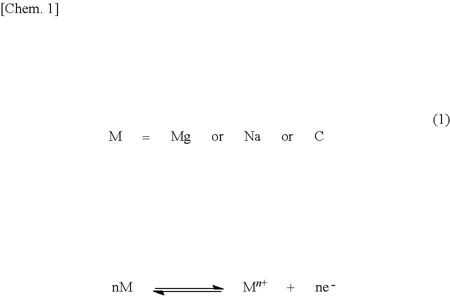

(In the case of Mg and Ca, n=2 and in the case of Na, n=1)

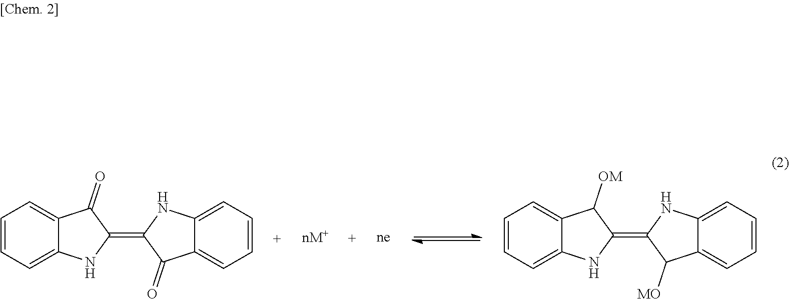

The C═O double bond with oxygen in the indigo contained in the positive electrode 101 is electrochemically reduced and the metal ions are bonded to each other so that a discharge reaction progresses. During charging, the reaction proceeds in the opposite direction.

The indigo contained in the positive electrode 101 may be in a polymerized state. The polymerized state refers to a molecule which maintains the redox function of indigo and has a large molecular weight. A known method can be used for polymerizing indigo.

By using a polymer compound as the positive electrode active material contained in the positive electrode 101, dissolution thereof in an electrolyte due to electrochemical reactions is difficult and excellent stability with little deterioration can be expected over a long period of time. Note that the molecular weight of the polymer compound is preferably 10,000 or more, and more preferably 100,000 or more.

The theoretical electromotive force is approximately 1.8 V when using indigo as the positive electrode active material and Mg as the negative electrode active material and approximately 2.2 V when using indigo as the positive electrode active material and Na or Ca as the negative electrode active material.

The secondary battery of the embodiment uses indigo as the positive electrode active material, magnesium, sodium, or calcium as the negative electrode active material and uses a nonaqueous electrolyte as the electrolyte so that it can be expected to be a battery with low environmental impact. In addition, the secondary battery of the embodiment is a sealed battery which does not require the air intake port required for air batteries by using indigo as the positive electrode active material. For this reason, the secondary battery of the embodiment can be stored for a long period of time without the electrolytic solution volatilizing from the air intake port.

The positive electrode 101 can contain a positive electrode active material and a conductive additive as constituent elements. The negative electrode 103 can contain a negative electrode active material and a conductive additive as constituent elements.

Each component of the secondary battery will be explained below.

### (1) Positive Electrode

The positive electrode contains at least a positive electrode active material and may also include a conductive additive or a current collector which will be described later as necessary. Also, it is preferable to form the positive electrode without a binder on a porous current collector containing at least one selected from the group consisting of aluminum, copper, and iron or a non-woven current collector containing carbon.

Furthermore, it is preferable that the positive electrode be formed in a co-continuum of a three-dimensional network structure in which a plurality of nanostructures are integrated through non-covalent bonds. A co-continuum has a three-dimensional network structure in which a plurality of nanostructures integrated through non-covalent bonds have branches.

Note that specific examples of the binder include polytetrafluoroethylene (PTFE), polyvinylidene fluoride (PVDF), styrene butadiene rubber, ethylene propylene diene rubber, and natural rubber.

As described above, by producing a positive electrode containing indigo as a positive electrode active material, a positive electrode which is highly active for charging reactions and discharging reactions can be obtained.

Furthermore, by forming the positive electrode on the porous current collector, the carbon-including a non-woven fabric current collector or the co-continuum, it is possible to fully bring out the potential of indigo which is the positive electrode active material.

### (1-1) Positive Active Material

The positive electrode active material of the embodiment contains at least indigo. Since indigo is derived from living organisms, it has a low environmental impact and is also inexpensive.

Furthermore, it is preferable that the positive electrode active material be in a polymer state. This is because, if the molecular weight of the positive electrode active material is small, it will easily dissolve in the electrolyte. The molecular weight of the positive electrode active material is preferably 10,000 or more, and more preferably 100,000 or more.

Indigo can be obtained, for example, as a commercial product or through known synthesis.

(1-2) Preparation of Positive Electrode using Conductive Additive

In the embodiment, a conductive additive may be included in the positive electrode. For example, carbon or the like can be used as the conductive auxiliary agent. Specifically, carbon blacks such as Ketjen black and acetylene black, activated carbons, graphites, and carbon fibers can be exemplified.

In order to secure enough reaction sites in the positive electrode, carbon with small particles is suitable. Specifically, particles with a particle diameter of 1 μm or less are preferable. These carbons can be obtained, for example, as commercial products or through known synthesis.

A positive electrode can be prepared by mixing indigo powder which is a positive electrode active material and the above-described conductive auxiliary agent and supporting this mixture on a conductive material. If necessary, a binder may be included in the mixture.

(1-3) Preparation of Positive Electrode using Current Collector

A positive electrode is formed on a porous current collector containing at least one selected from the group consisting of aluminum, copper, and iron or a non-woven fabric current collector containing carbon and the positive electrode may not contain a binder. Specifically, the positive electrode active material may be directly supported on such a current collector. Direct support means that the positive electrode active material is finely bonded to the current collector in a three-dimensional structure. Thus, conductivity can be improved. When not directly supported, for example, when a current collector disk is placed on a positive electrode active material disk, the current collector and the positive electrode active material are in plane contact. Thus, the conductivity is lower than in the case of direct support. The above-described porous current collector and non-woven fabric current collector can be obtained as, for example, commercial products.

Furthermore, the positive electrode is formed as a co-continuum of a three-dimensional network structure in which a plurality of nanostructures are integrated using non-covalent bonds and the positive electrode does not need to contain a binder. Specifically, a positive electrode active material may be supported on the co-continuum. The co-continuum is a monolithic structure in which the joints between nanostructures are deformable and stretchable. Preferably, the co-continuum has, for example, an average pore size of 0.1 μm to 50 μm.

The nanostructure is, for example, a nanosheet or nanofiber, and is characterized by having electrical conductivity. This nanosheet contains, for example, graphene. Graphene nanofibers are fibrous materials with diameters ranging from 1 nm to 1 μm and lengths over 100 times the diameter. Examples of the nanofiber include iron oxide, manganese oxide, silicon, and carbonized cellulose. Carbonized cellulose can be produced by producing a gel in which cellulose nanofibers are dispersed and heating and carbonizing this gel in an inert gas atmosphere.

The co-continuum can be produced by drying a frozen body obtained by freezing a sol or gel in which nanostructures such as nanosheets and nanofibers are dispersed in a vacuum.

Specifically, the dispersion medium of the sol is aqueous systems such as water or organic systems such as carboxylic acid, methanol, ethanol, propanol, n-butanol, isobutanol, n-butylamine, dodecane, unsaturated fatty acids, ethylene glycol, heptane, hexadecane, isoamyl alcohol, octanol, isopropanol, acetone, and glycerin and may be a mixture of two or more of these.

Specifically, the gel dispersion medium is aqueous systems such as water (H₂O) or organic systems such as carboxylic acid, methanol (CH₃OH), ethanol (C₂H₅OH), propanol (C₃H₇OH), n-butanol, isobutanol, n-butylamine, dodecane, unsaturated fatty acids, ethylene glycol, heptane, hexadecane, isoamyl alcohol, octanol, isopropanol, acetone, glycerin and may be a mixture of two or more of these.

The degree of vacuum in the drying step varies depending on the dispersion medium used, but is not particularly limited as long as the degree of vacuum allows the dispersion medium to sublimate. For example, although it is necessary to maintain a degree of vacuum with a pressure of 0.06 MPa or less when water is used as a dispersion medium, heat is taken away as latent heat of sublimation. That, it takes time to dry. For this reason, the degree of vacuum is preferably from 1.0×10⁻⁶ to 1.0×10⁻² Pa. Furthermore, heat may be applied using a heater or the like during drying.

This co-continuum can have a larger specific surface area than commercially available conductive porous bodies or non-woven fabric current collectors. The specific surface area of this co-continuum is preferably 200 m²/g or more. Note that the co-continuum is also referred to as a copolymer.

It is considered that the following methods can support the positive electrode active material on the above-described porous current collector, non-woven fabric current collector, and co-continuum. For example, there are physical methods such as evaporation, sputtering, and planetary ball mills, a method for immersing the above-described porous current collector, non-woven fabric current collector, and co-continuum in a liquid in which the positive electrode active material is dissolved and drying it, chemical methods such as sol-gel method, other known methods, and the like.

In order to form a simple and high quality positive electrode, a method in which a positive electrode active material is supported by impregnating the above-described porous current collector, non-woven fabric current collector, and co-continuum with a liquid in which the positive electrode active material is dissolved and drying it is preferred. Here, by applying cold pressing or hot pressing to the dried electrode (positive electrode), the strength of the electrode can be increased and a positive electrode with better stability can be produced.

Specifically, the for dissolving the positive solvent electrode active material is aqueous systems such as water or organic systems such as tetrahydrofuran (THF), tetrahydropran (THP), dioxane, diethyl ether, N-methyl-2-pyrrolidone (NMP), hexamethylphosphoric acid amide (HMPA), tetramethylurea (TMU), dimethylacetamide (DMAc), dimethyl formaldehyde (DMF), dimethyl sulfoxide (DMSO), m-cresol, and chloroform and may be obtained by mixing two or more of these.

In the secondary battery of the embodiment, since the reaction represented by Expression (2) proceeds on the surface of the positive electrode, it is considered better to generate a large amount of reaction sites inside the positive electrode. In the case of a positive electrode molded using the above-described conductive auxiliary agent and binder, when the specific surface area is increased, the binding strength within the conductive auxiliary agent decreases and the structure deteriorates, making it difficult to discharge stably and reducing the discharge capacity. Since the binder is an insulating substance, if a large amount of the binder is included, the conductivity decreases, leading to a decrease in battery performance (discharge voltage, discharge capacity). In addition, when using Ketjen black powder as a conductive additive, it is difficult to increase the specific surface area from the viewpoint of binding strength.

On the other hand, a positive electrode formed using the porous current collector, the non-woven fabric current collector, or the co-continuum described above can secure a large amount of reaction sites and solve the above-described problems. Thus, it becomes possible to increase the discharge capacity. Particularly, the co-continuum has a high bulk density and can support a larger amount of positive electrode active material, thereby increasing the efficiency of the battery.

As described above, by producing a positive electrode containing indigo as a positive electrode active material, a positive electrode which is highly active for charging reactions and discharging reactions can be obtained. Furthermore, it is possible to fully bring out the potential of indigo which is a positive electrode active material by forming the positive electrode on the porous current collector, the non-woven fabric current collector containing carbon, or the co-continuum.

### (2) Negative Electrode

The secondary battery of the embodiment contains at least magnesium (Mg), sodium (Na), or calcium (Ca) as a negative electrode active material. The negative electrode active material may include magnesium (Mg), sodium (Na), or calcium (Ca) as a main component and may also be an alloy containing at least one component selected from the group consisting of lithium (Li), zinc (Zn), aluminum (Al), manganese (Mn), iron (Fe), tin (Sn), and carbon (C).

### (3) Non-aqueous Electrolyte (Electrolyte)

The secondary battery of the embodiment includes a non-aqueous electrolyte. The non-aqueous electrolyte is a solution containing an electrolyte which allows movement of magnesium ions (Mg²⁺), sodium ions (Nat), or calcium ions (Ca²⁺).

The non-aqueous electrolyte uses an organic solvent as a main solvent and may also contain solvents other than this organic solvent, for example, water. For example, as the non-aqueous electrolytes, an electrolytic solution in which a magnesium salt, a sodium salt, or a calcium salt is dissolved in at least one organic solvent selected from the group consisting of a carbonate ester-based solvent such as dimethyl carbonate (DMC), methyl ethyl carbonate (MEC), methyl propyl carbonate (MPC), methyl isopropyl carbonate (MIPC), methyl butyl carbonate (MBC), diethyl carbonate (DEC), ethyl propyl carbonate (EPC), ethyl isopropyl carbonate (EIPC), ethyl butyl carbonate (EBC), dipropyl carbonate (DPC), diisopropyl carbonate (DIPC), dibutyl carbonate (DBC), ethylene carbonate (EC), propylene carbonate (PC), and 1,2-butylene carbonate (1,2-BC), an ether-based solvent such as 1, 2-dimethoxyethane (DME) and tetraethylene glycol dimethyl ether (TEGDME), a lactone-based t such as Y—Butyrotactone (GBL), and a sulfoxide-based solvent such as dimethyl sulfoxide (DMSO) can be used.

Magnesium salts, sodium salts and calcium salts are represented by Mg—X₂, Na—X, and Ca—X₂, respectively. Here, examples of X include Cl, Br, I, BF₄, PF₆, CF₃SO₃, ClO₄, CF₃CO₂, ASF₆, SbF₆, AlCl₄, N(CF₃SO₂), N(CF₃CF₂SO₂)₂, PF₃ (C₂F₅)₃, N(ESO₂), N(ESO₂) (CF₃SO₂), N(CF₃CF₂SO₂), N(C₂F₄S₂O₄), N(CF₆SO₄), N(CN), N(CF₃SO₂) (CF₃CO), R₁FBF₃ (where R₁F=n−CₘF₂ₘ₊₁, m=a natural number from 1 to 4) and R₂BF₃ (where R₂=n−CₚH₂ₚ₊₁, p=a natural number from 1 to 5). Furthermore, a metal salt obtained by mixing two or more of these metal salts can be used.

Although the non-aqueous electrolyte is used as the electrolyte in the embodiment, a solid electrolyte such as a gel or solid electrolyte may also be used. That is to say, the electrolyte may be in any form such as liquid, cream, gel, or solid.

### (4) Other Elements

In addition to the above-described constituent elements, the secondary battery of the embodiment can include structural members such as a separator and a battery case and other elements required for a secondary battery. Although the known materials in the related art can be used, from the viewpoint of environmental impact and disposal, it is preferable that they do not contain harmful substances, precious metals, and the like. Furthermore, it is more preferable that these other elements be biologically derived and biodegradable materials.

### (5) Method for Producing Secondary Battery

As described above, the secondary battery of the embodiment includes at least a positive electrode, a negative electrode, and a non-aqueous electrolyte. In addition, as shown in FIG. 1, a non-aqueous electrolyte is placed between a positive electrode and a negative electrode to be in contact with the positive electrode and the negative electrode. A secondary battery having such a configuration can be prepared in the same manner as in a conventional secondary battery.

For example, a secondary battery may be obtained by assembling a positive electrode containing a positive electrode active material containing indigo as described above, a negative electrode containing magnesium (Mg), sodium (Na), or calcium (Ca), and a non-aqueous electrolyte placed in contact with the positive and negative electrodes in accordance with the technique in the related art.

As an embodiment of the method for producing a secondary battery, for example, a coin-type secondary battery can be produced.

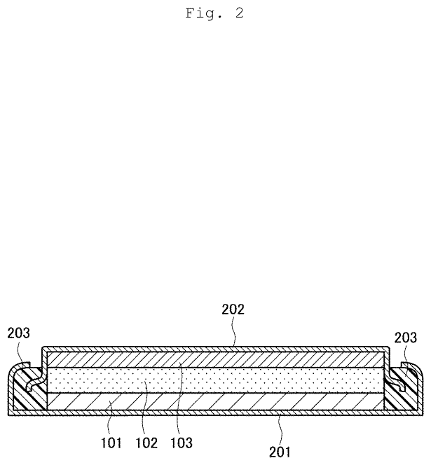

FIG. 2 is a schematic cross-sectional view showing a structure of a coin-type secondary battery. Specifically, first, a separator (not shown) is placed on the positive electrode case 201 in which the positive electrode 101 is installed and the electrolyte 102 is injected into the placed separator. Next, the negative electrode 103 is placed above the electrolyte 102 and the negative electrode case 202 is placed over the positive electrode case 201. Next, by caulking the peripheral edges of the positive electrode case 201 and the negative electrode case 202 using a coin cell caulking machine, it is possible to produce a coin-shaped secondary battery including a propylene gasket 203.

The shown coin-type secondary battery uses indigo as a positive electrode active material. For this reason, in the embodiment, a sealed battery can be produced and stored for a long period of time.

### EXAMPLES

Examples of the secondary battery according to this embodiment will be described in detail below. In each of the examples, three types of secondary batteries were produced using magnesium (Mg), sodium (Na), and calcium (Ca) for the negative electrode and using a propylene carbonate solution containing Mg[N(SO₂CF₃)₂]₂, NaN(SO₂CF₃): and Ca[N(SO₂CF₃)₂]₂ for the non-aqueous electrolyte. Note that the present invention is not limited to the configuration shown in the following examples, but can be practiced with appropriate modifications within the scope of the gist thereof.

### Example 1

In Example 1, the above-described coin-shaped secondary battery (FIG. 2) was produced using the following procedure. Furthermore, indigo was used as a positive electrode active material. In addition, indigo was used as a positive electrode active material and prepared by pressing indigo onto a porous current collector containing copper (copper mesh, CU-118016, Nilaco Co., Ltd.). A magnesium (Mg) foil, a sodium (Na) foil, and a calcium (Ca) foil were used as negative electrode active materials, respectively. A propylene carbonate solution containing 0.5 mol/L of Mg[N(SO₂CF₃)₂]₂, NaN(SO₂CF₃)₂ and Ca[N(SO₂CF₃)₂]₂ was used as the nonaqueous electrolyte.

### (Preparation of Positive Electrode)

A sheet-like electrode (thickness: 0.5 mm) was produced by grinding and mixing an indigo powder (Sigma-Aldrich CO. LLC), a Ketjen black powder (EC600JD, Lion Specialty Chemicals Co., Ltd.), and a polytetrafluoroethylene (PTFE) powder thoroughly using a crusher at a weight ratio of 80:10:10 and roll-forming the mixture. This sheet-like electrode and copper mesh current collector were cut out into a circle with a diameter of 16 mm and the circular sheet-like electrode was pressed onto the circular copper mesh to obtain a positive electrode.

### (Preparation of Negative Electrode)

A magnesium (Mg) foil (thickness 150 μm, Nilaco Co., Ltd.), a sodium (Na) foil (thickness 150 μm, Sigma-Aldrich CO. LLC), and a calcium (Ca) foil (thickness 150 μm, Nilaco Co., Ltd.) were cut out to have a circular shape with a diameter of 16 mm and these were each bonded to a copper foil (Nilaco Co., Ltd.) using an ultrasonic welder.

### (Preparation of Secondary Battery)

A coin-shaped secondary battery shown in FIG. 2 was fabricated using a coin battery case (Hohsen Corp.).

A cellulose separator (Nippon Kodoshi Kogyo Co., Ltd.) cut out to have a diameter of 18 mm was placed on the positive electrode case 201 in which the positive electrode 101 prepared in the above method was installed and a propylene carbonate solution (Kishida Chemical Co., Ltd.) containing Mg[N(SO₂CF₃)], NaN(SO₂CF₃), and Ca[N(SO₂CF₃)₂]₂ is injected into the installed separator as a non-aqueous electrolyte 102.

A coin-type secondary battery containing the propylene gasket 203 was obtained by placing the negative electrode 103 above the non-aqueous electrolyte 102, placing the negative electrode case 202 over the positive electrode case 201, and caulking the peripheral edges of the positive electrode case 201 and the negative electrode case 202 using a coin cell caulking machine.

### (Battery Performance)

The battery performance of the secondary battery prepared according to the above procedure was measured. In the battery cycle test, a charge/discharge measurement system (manufactured by Bio Logic) was used for passing a current at a current density of 1.0 mA/cm² per effective area of the positive electrode and the discharge voltage was measured until the battery voltage decreased to 0.10 V from the open circuit voltage. The battery discharge test was performed under normal living conditions. The discharge capacity was expressed as a value per unit weight of the positive electrode active material (indigo) (mAh/g).

Table 1 shows the discharge capacity and the discharge voltage of the secondary battery of Example 1. As shown in Table 1, the discharge voltage of Example 1 in a battery using magnesium (Mg), sodium (Na), and calcium (Ca) in the negative electrode was 0.51 V, 0.98 V, and 1.06 V, and the discharge capacities were 89 mAh/g, 145 mAh/g, and 105 mAh/g, respectively. Here, the discharge voltage is defined as the discharge voltage when the discharge capacity is ½ of the total discharge capacity. Thus, it was found that the secondary battery of Example 1 had excellent battery performance.

TABLE 1

| Examples | Negative active material | Mg | Na | Ca |
|---|---|---|---|---|
| Example 1 | Discharge voltage (V) | 0.51 | 0.98 | 1.06 |
| | Discharge capacity (mAh/g) | 89 | 145 | 105 |
| Example 2 | Discharge voltage (V) | 1.13 | 1.50 | 1.72 |
| | Discharge capacity (mAh/g) | 127 | 170 | 153 |
| Example 3 | Discharge voltage (V) | 1.41 | 1.80 | 2.03 |
| | Discharge capacity (mAh/g) | 163 | 224 | 218 |

### Example 2

In Example 2, the above-described coin-shaped secondary battery was produced using the following procedure. In addition, preparation was performed by using indigo as a positive electrode active material and supporting indigo on a nonwoven current collector (carbon felt) containing carbon. A magnesium (Mg) foil, a sodium (Na) foil, and a calcium (Ca) foil were used as negative electrode active materials, respectively. A propylene carbonate solution containing 0.5 mol/L of Mg[N(SO₂CF₃)₂]₂, NaN(SO₂CF₃)₂, and Ca[N(SO₂CF₃)₂]₂ was used as the non-aqueous electrolyte. The battery was evaluated in the same manner as in Example 1.

### (Preparation of Positive Electrode)

Carbon felt (Toyobo Co., Ltd.) was immersed in a liquid in which indigo powder (Sigma-Aldrich CO. LLC) was dissolved in 1.0 M hydrochloric acid (Tokyo Kasei Kogyo Co., Ltd.). This carbon felt was dried in a vacuum dryer at 80° C. for 30 minutes to precipitate indigo onto the carbon felt which was then washed with pure water. Also, this indigo-containing carbon felt was cut into a circle with a diameter of 16 mm to obtain a positive electrode.

### (Preparation of Negative Electrode)

A magnesium (Mg) foil (thickness 150 μm, Nilaco Co., Ltd.), a sodium (Na) foil (thickness 150 μm, Sigma-Aldrich Co. LLC), and a calcium (Ca) foil (thickness 150 μm, Nilaco Co., Ltd.) were cut out to have a circular shape with a diameter of 16 mm and these were each bonded to a copper foil (Nilaco Co., Ltd.) using an ultrasonic welder.

### (Preparation of Secondary Battery)

A coin-shaped secondary battery shown in FIG. 2 was fabricated using a coin battery case (Hohsen Corp.).

A cellulose separator (Nippon Kodoshi Kogyo Co., Ltd.) cut out to have a diameter of 18 mm was placed on each of the positive electrode cases 201 in which the positive electrode 101 prepared in the above method was installed and a propylene carbonate solution (Kishida Chemical Co., Ltd.) containing Mg[N(SO₂CF₃)₂]₂, NaN(SO₂CF₃)₂, and Ca[N(SO₂CF₃)₂]₂ was injected into the installed separator as a non-aqueous electrolyte 102. A coin-type secondary battery containing the propylene gasket 203 was obtained by placing the negative electrode 103 above the non-aqueous electrolyte 102, placing the negative electrode case 202 over the positive electrode case 201, and caulking the peripheral edges of the positive electrode case 201 and the negative electrode case 202 using a coin cell caulking machine.

### (Battery Performance)

Table 1 shows the discharge capacity and the discharge voltage of the secondary battery of Example 2. As shown in Table 1, the discharge capacity of Example 2 in a battery using magnesium (Mg) for the negative electrode was 127 mAh/g which was a larger value than Example 1. The discharge capacity of the battery using sodium (Na) and calcium (Ca) for the negative electrode was also larger than that of Example 2.

Furthermore, as shown in Table 1, the discharge voltage of Example 2 is higher than that of Example 1. That is to say, in Example 2, a reduction in overvoltage was observed compared to Example 1 and an improvement in the energy efficiency of discharge could be achieved.

These improvements in characteristics are thought to be due to the use of a positive electrode formed by supporting a positive electrode active material on the carbon felt which reduced the internal resistance of the battery and enabled efficient battery reactions.

### Example 3

In Example 3, the above-described coin-shaped secondary battery was produced using the following procedure. In addition, preparation was performed by using indigo as a positive electrode active material and supporting indigo on a co-continuum. A magnesium (Mg) foil, a sodium (Na) foil, and a calcium (Ca) foil were used as negative electrode active materials, respectively. A propylene carbonate solution containing 0.5 mol/L of Mg[N(SO₂CF₃)₂]₂, NaN(SO₂CF₃)₂, and Ca[N(SO₂CF₃)₂]₂ was used as the nonaqueous electrolyte.

The battery was evaluated in the same manner as in Examples 1 and 2.

### (Preparation of Positive Electrode)

The co-continuum was immersed in a liquid in which indigo powder (Sigma-Aldrich Co. LLC) was dissolved in 1.0 M hydrochloric acid (Tokyo Kasei Kogyo Co., Ltd.). This co-continuum was dried for 30 minutes in a vacuum dryer at 80° C. to precipitate indigo into the co-continuum which was then washed with pure water. Also, this indigo-containing co-continuum was cut out to have a circle shape with a diameter of 16 mm to obtain a positive electrode.

In the preparation of the above-described co-continuum, first, a bacterial cellulose gel produced by the acetic acid bacterium Acetobacter xylinum was placed in a test tube and the test tube was immersed in liquid nitrogen for 30 minutes to completely freeze the bacterial cellulose gel. Subsequently, the frozen bacterial cellulose gel was taken out into an eggplant flask and dried in a vacuum of 10 Pa or less using a freeze dryer (Tokyo Rika Kikai Co., Ltd.). After that, the co-continuum was produced by carbonizing it by firing at 1200° C. for 2 hours in a nitrogen atmosphere.

### (Preparation of Negative Electrode)

A magnesium (Mg) foil (thickness 150 μm, Nilaco Co., Ltd.), a sodium (Na) foil (thickness 150 μm, Sigma-Aldrich Co. LLC), a calcium (Ca) foil (thickness 150 μm, Nilaco Co., Ltd.) were cut out to have a circular shape with a diameter of 16 mm and each of these pieces was joined to a copper foil (Nilaco Co., Ltd.) using an ultrasonic welder.

### (Preparation of Secondary Battery)

A coin-shaped secondary battery shown in FIG. 2 was produced using a coin battery case (Hohsen Corp.).

A cellulose separator (Nippon Kodoshi Kogyo Co., Ltd.) cut out to have a diameter of 18 mm was placed on each of the positive electrode cases 201 in which the positive electrode 101 prepared in the above method was installed and a propylene carbonate solution (Kishida Chemical Co., Ltd.) containing Mg[N(SO₂CF₃)₂]₂, NaN(SO₂CF₃)₂, and Ca[N(SO₂CF₃)₂]₂ is injected into the installed separator as a non-aqueous electrolyte 102. A coin-type secondary battery containing the propylene gasket 203 was obtained by placing the negative electrode 103 above the non-aqueous electrolyte 102, placing the negative electrode case 202 over the positive electrode case 201, and caulking the peripheral edges of the positive electrode case 201 and the negative electrode case 202 using a coin cell caulking machine.

### (Battery Performance)

Table 1 shows the discharge capacity and the discharge voltage of the secondary battery of Example 3. As shown in Table 1, the discharge capacity of Example 3 in a battery using magnesium (Mg) for the negative electrode was 163 mAh/g which was a larger value than Examples 1 and 2. The discharge capacities of the batteries using sodium (Na) and calcium (Ca) in the negative electrode were also larger than those of Examples 1 and 2.

Furthermore, as shown in Table 1, the discharge voltage of Example 3 is higher than the discharge voltages of Example 1 and Example 2. That is to say, in Example 3, a decrease in overvoltage was observed compared to Examples 1 and 2 and it was possible to achieve an improvement in the energy efficiency of discharge.

These improvements in properties are considered to be due to the fact that the amount of the positive electrode active material supported increased due to the use of a positive electrode formed by supporting the positive electrode active material in a co-continuum.

Furthermore, as shown in Table 2, the discharge capacity of the battery using magnesium (Mg) in the negative electrode of Example 3 after 20 cycles was 161 mAh/g which was a larger value than Examples 1 and 2. The discharge capacities of the batteries using sodium (Na) and calcium (Ca) in the negative electrode were also larger than those of Examples 1 and 2.

TABLE 2

| Examples | Negative active material | Mg | Na | Ca |
|---|---|---|---|---|
| Example 1 | Discharge capacity | 4 | 6 | 6 |
| | after 20 cycles (mAh/g) | | | |
| Example 2 | Discharge capacity | 11 | 16 | 13 |
| | after 20 cycles (mAh/g) | | | |
| Example 3 | Discharge capacity | 161 | 221 | 217 |
| | after 20 cycles (mAh/g) | | | |

It is thought that the improvement in these properties is due to the fact that, since a positive electrode formed by supporting the positive electrode active material on the above-described co-continuum was used, the amount of positive electrode active material supported has increased and it has also become difficult for the positive electrode active material to dissolve in the electrolyte through electrochemical reactions.

Furthermore, the secondary battery of the embodiment is a sealed battery which uses indigo as the positive electrode active material and does not require an air intake port unlike an air battery. For this reason, the secondary battery of the embodiment can be stored for a long period of time without the electrolytic solution volatilizing from the air intake port.

Therefore, the secondary battery of the embodiment can be effectively used as a new driving source for various electronic devices such as small devices, sensors, and mobile devices.

Note that the present invention is not limited to the above embodiments, and various modifications and combinations are possible within the technical idea of the present invention.

### REFERENCE SIGNS LIST

100 Secondary battery
101 Positive electrode
102 Non-aqueous electrolyte (electrolyte)
103 Negative electrode
201 Positive electrode case
202 Negative electrode case
203 Propylene gasket

1. A secondary battery, comprising:
a positive electrode containing indigo;
a negative electrode containing magnesium, sodium or calcium; and
an electrolyte disposed between the positive electrode and the negative electrode.

2. The secondary battery according to claim 1, wherein the positive electrode is formed on a porous current collector containing at least one selected from the group consisting of aluminum, copper, and iron or a non-woven fabric current collector containing carbon, and
the positive electrode does not contain a binder.

3. The secondary battery according to claim 1, wherein the positive electrode is formed in a co-continuum of a three-dimensional network structure in which a plurality of nanostructures are integrated, and
the positive electrode does not contain a binder.
